(19) United States
(12) Patent Application Publication
(10) Pub. No.: US 2009/0209742 A1
(43) Pub. Date: Aug. 20, 2009

(54) DISPERSE DYES, PRODUCTION AND USE

(75) Inventor: Andreas Endres, Leverkusen (DE)

Correspondence Address: CONNOLLY BOVE LODGE & HUTZ, LLP, P O BOX 2207, WILMINGTON, DE, 19899, US

(73) Assignee: DyStar Textilfarben GmbH & Co. Deutschland KG, Frankfurt am Main (DE)

(21) Appl. No.: 12/304,491

(22) PCT Filed: Jun. 6, 2007
(86) PCT No.: PCT/EP07/55578

§ 371 Date: Jan. 22, 2009

(30) Foreign Application Priority Data
Jun. 14, 2006 (DE) 10 2006 027 535.7

(51) Int. Cl. C09B 43/42; C09B 46/00

(52) U.S. Cl. 534/597; 534/733

(57) ABSTRACT

The present invention relates to dyes of the general formula (I)

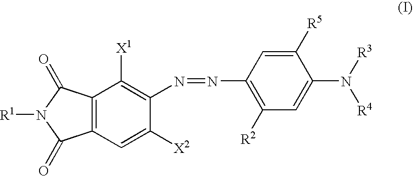

where
X¹ and X² are both hydrogen or both cyano;
R¹ is ethyl, straight-chain or branched (C₃-C₁₀)-alkyl or —(CH₂)ₙCOO⁶;
R² is hydrogen, methyl, cyanomethyl, halomethyl, ethyl, cyanoethyl, haloethyl, halogen, —NH—CO—R⁷ or —NH—SO₂—R⁷;
R³ is (C₁-C₈)-alkyl or hydroxyl-, (C₁-C₄)-alkoxy-, cyano-, halogen-, R⁷OCO—, R⁷OOC—, vinyl- or phenyl-substituted (C₁-C₈)-alkyl;
R⁴ is hydrogen, (C₁-C₈)-alkyl or hydroxyl-, (C₁-C₄)-alkoxy-, cyano-, halogen-, R⁷OCO—, R⁷OOC—, vinyl or phenyl-substituted (C₁-C₈)-alkyl;
R⁵ is hydrogen, halogen, (C₁-C₄)-alkyl, (C₁-C₈)-alkoxy or halogen-, cyano- or phenyl-substituted (C₁-C₈)-alkoxy;
R⁶ is (C₁-C₄)-alkyl;
R⁷ is (C₁-C₈)-alkyl or halogen- or cyano-substituted (C₁-C₈)-alkyl; and
n is 1, 2, 3, 4 or 5. The invention also relates to the process of the preparation of the dyes of formula (I) and their use.

The present invention relates to disperse dyes comprising an N-substituted phthalimide diazo component and a coupling component of the aniline series, to processes for their preparation and to their use for dyeing textile materials.

Disperse dyes of this kind are already known and described for example in FR 1,358,145, U.S. Pat. No. 3,980,634, U.S. Pat. No. 4,039,522, EP 0 051 563 A1, EP 0 443 984 A1, EP 0 667 376 A1, WO 00/40656, WO 02/68539, WO 02/74864 and WO 04/44058. However, they have some disadvantages in that, for example, they do not meet present-day requirements in relation to certain washfastnesses.

It has now been found that, surprisingly, the dyes defined hereinbelow meet the stated requirements and also possess superior buildup, superior temperature dependence of the dyeing and also higher pH stability.

The present invention accordingly provides dyes of the general formula (I)

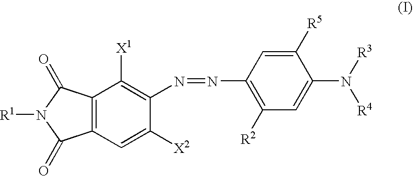

where
X¹ and X² are both hydrogen or both cyano;
R¹ is ethyl, straight-chain or branched (C₃-C₁₀)-alkyl or —(CH₂)ₙCOOR⁶;
R² is hydrogen, methyl, cyanomethyl, halomethyl, ethyl, cyanoethyl, haloethyl, halogen, —NH—CO—R⁷ or —NH—SO₂—R⁷;
R³ is (C₁-C₈)-alkyl or hydroxyl-, (C₁-C₄)-alkoxy-, cyano-, halogen-, R⁷OCO—, R⁷OOC—, vinyl- or phenyl-substituted (C₁-C₈)-alkyl;
R⁴ is hydrogen, (C₁-C₈)-alkyl or hydroxyl-, (C₁-C₄)-alkoxy-, cyano-, halogen-, R⁷OCO—, R⁷OOC—, vinyl or phenyl-substituted (C₁-C₈)-alkyl;
R⁵ is hydrogen, halogen, (C₁-C₄)-alkyl, (C₁-C₈)-alkoxy or halogen-, cyano- or phenyl-substituted (C₁-C₈)-alkoxy;
R⁶ is (C₁-C₄)-alkyl;
R⁷ is (C₁-C₈)-alkyl or halogen- or cyano-substituted (C₁-C₈)-alkyl; and
n is 1, 2, 3, 4 or 5;
   except that
   compounds in which R¹ is ethyl or n-butyl, X¹ and X² are both cyano and R² is —NH—CO—R⁷, where R⁷═C₁-alkyl;
   compounds in which R¹ is ethyl or n-butyl, X¹ and X² are both hydrogen and R² is —NH—CO—R⁷ or —NH—SO₂—R⁷;
   the compound in which R¹ is —(CH₂)ₙCOOR⁶ where n=2 and R⁶═C₁-alkyl, X¹ and X² are both hydrogen, R² is —NH—CO—R⁷ where R⁷═C₂-alkyl, one of R³ and R⁴ is C₂-alkyl and the other is R⁷OCO-substituted C₂-alkyl where R⁷═C₁-alkyl and R⁵ is hydrogen;
   compounds in which R¹ is branched C₃-alkyl, X¹ and X² are both hydrogen, R² is —NH—CO—R⁷ where R⁷═C₃-alkyl, R³ and R⁴ are both C₂-alkyl and R⁵ is hydrogen; and
   compounds in which R¹ is isobutyl, X¹ and X² are both hydrogen, R² is —NH—CO—R⁷ where R⁷═C₆-alkyl or is —NH—SO₂—R⁷ where R⁷═C₁-alkyl, R³ and R⁴ are both C₂-alkyl and R⁵ is hydrogen;
   shall be excluded.

Straight-chain (C₃-C₁₀)-alkyl R¹ may be n-propyl, n-butyl, n-pentyl, n-hexyl, n-heptyl, n-octyl, n-nonyl or n-decyl.

Branched (C₃-C₁₀)-alkyl R¹ may be for example isopropyl, isobutyl, sec-butyl or tert-butyl.

Straight-chain (C₃-C₁₀)-alkyl is preferred.

When R¹ is ethyl or n-butyl, R² is preferably cyanomethyl, halomethyl, ethyl, cyanoethyl, haloethyl, halogen, —NH—CO—R⁷ or —NH—SO₂—R⁷.

—NH—CO—R⁷R² is in particular acetylamino and propionylamino, while —NH—SO₂—R⁷R² is in particular methylsulfamino and ethylsulfamino.

(C₁-C₈)-Alkyl R³ or R⁷, substituted or unsubstituted, may be straight-chain or branched and is, for example, methyl, ethyl, n-propyl, isopropyl, n-butyl, isobutyl, sec-butyl, or tert-butyl or straight-chain or branched pentyl, hexyl, heptyl or octyl. (C₁-C₄)-Alkyl is preferred and methyl and ethyl are particularly preferred.

The same logic applies to (C₁-C₄)-alkyl R⁶, which is thus preferably methyl or ethyl, and also to (C₁-C₈)-alkoxy R⁵, which accordingly is preferably (C₁-C₄)-alkoxy and more preferably methoxy or ethoxy. (C₁-C₄)-Alkoxy as a substituent on (C₁-C₈)-alkyl R³ or R⁴ is likewise preferably methoxy or ethoxy.

Halogen is preferably fluorine, chlorine or bromine and more preferably chlorine or bromine.

R⁵ is preferably hydrogen.

Preferred dyes according to the present invention conform to the general formula (Ia)

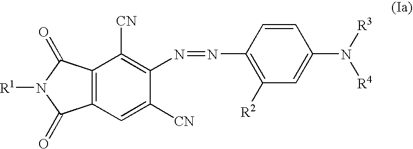

where
R¹ is n-pentyl or —(CH₂)ₙCOOR⁶;
R² is methyl, —NH—CO-methyl or —NH—SO₂-methyl;
R³ and R⁴ are independently ethyl, —(CH₂)₂CN, —(CH₂)₂OMe, —(CH₂)₂OAc, or n-butyl;
R⁶ is methyl, ethyl or butyl; and
n is 1, 2 or 3.

Preferred dyes according to the present invention also conform to the general formula (Ib)

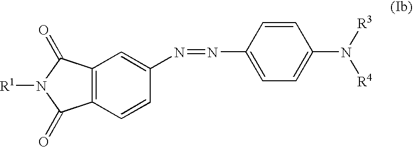

where
R¹ is ethyl or —(CH₂)ₙCOOR⁶;
R³ and R⁴ are independently ethyl, —(CH₂)₂CN, —(CH₂)₂OMe, —(CH₂)₂OAc, or n-butyl;
R⁶ is methyl, ethyl or butyl; and
n is 1, 2, 3 or 5.

Preferred dyes according to the present invention also conform to the general formula (Ic)

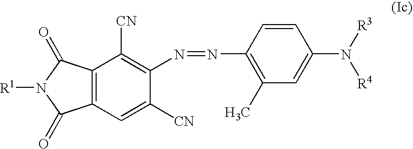

where
R¹ is isopropyl, isobutyl, sec-butyl or tert-butyl; and
R³ and R⁴ are independently ethyl, —(CH₂)₂CN, —(CH₂)₂OMe, —(CH₂)₂OAc, or n-butyl.

The present invention's dyes of the general formula (I) are obtainable using methods known to one skilled in the art.

For instance, present invention compounds in which X¹ and X² are both cyano are obtained by cyanating a compound of the general formula (II)

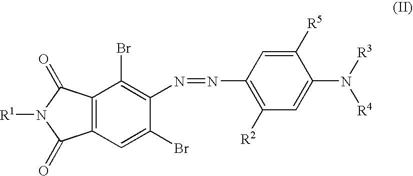

where R¹ to R⁵ are each as defined above.

The cyanating is preferably effected in a known manner, say with a mixture of copper(i) cyanide and zinc(II) cyanide in the presence of potassium iodide and imidazole in hot NMP.

The compounds of the general formula (II) are obtainable by diazotizing a compound of the general formula (III)

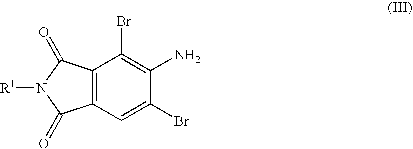

and coupling onto a compound of the general formula (IV)

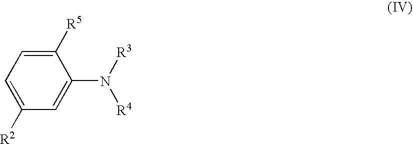

where R² to R⁵ are each as defined above.

The diazotizing of the compounds of the general formula (III) is generally effected in a known manner, for example using sodium nitrite in an aqueous medium rendered acidic, for example with hydrochloric or sulfuric acid, or using nitrosylsulfuric acid in dilute sulfuric acid, phosphoric acid or in a mixture of acetic acid and propionic acid. The preferred temperature range is between 0° C. and 15° C.

The coupling of the diazotized compounds onto the compounds of the general formula (IV) is generally likewise effected in a known manner, for example in an acidic, aqueous, aqueous-organic or organic medium, particularly advantageously at temperatures below 10° C. Acids used are in particular sulfuric acid, acetic acid or propionic acid.

The compounds of the general formula (IV) are known and can be prepared by known methods.

The compounds of the general formula (III) can be prepared for example as follows proceeding from phthalimide.

Phthalimide is nitrated, for example as described in Organic Synthesis, CV 2, page 459 (5th edition), and the 4-nitrophthalimide obtained is treated with aqueous sodium hydroxide solution to convert it into 4-nitrophthalic acid. Heating with acetic anhydride removes one molecule of water to obtain the corresponding anhydride. It is reacted with an amine of the general formula (V)

R¹—NH₂ (V)

where R¹ is as defined above, to form the compound of the general formula (VI)

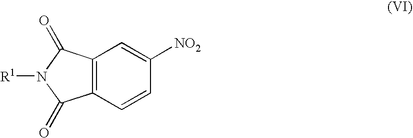

where R¹ is as defined above.

The reaction of the phthalic anhydride with the amine of the general formula (VI) is preferably carried out by introducing the phthalic anhydride into the amine and allowing the reaction to proceed for some hours at elevated temperature.

Reducing the compound of the general formula (VI) then gives the compound of the general formula (VII)

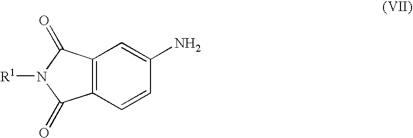

where R¹ is as defined above. The reduction is advantageously carried out by the method described in Chem. Pharm. Bull. 42(9), 1994, page 1817.

The compound of the general formula (VII) is finally brominated in glacial acetic acid to obtain the compound of the formula (III).

Performing the above-described diazotization and coupling reaction with a compound of the general formula (VII) instead of with a compound of the general formula (III), gives the present invention dyes of the general formula (I) wherein X¹ and X² are both hydrogen.

These last dyes according to the present invention are thus obtainable by a compound of the general formula (VII)

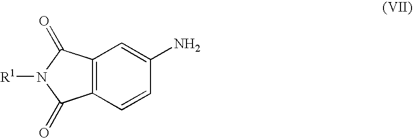

where R¹ is as defined above, being diazotized and coupled onto a compound of the general formula (IV)

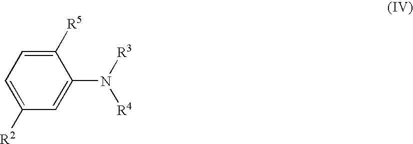

where R² to R⁵ are each as defined above.

The present invention's dyes of the general formula (I) are very useful for dyeing and printing hydrophobic materials, the dyeings and prints obtained being notable for level hues and high service fastnesses. Deserving of particular mention are good fastnesses to light, dry heat setting and pleating, water and perspiration, in particular very good washfastnesses, and also high reduction stability. The hydrophobic materials mentioned may be of synthetic or semisynthetic origin.

The present invention thus also provides for the use of the dyes of the general formula I for dyeing and printing hydrophobic materials, i.e., processes for dyeing or printing such materials in a conventional manner wherein one or more dyes of the general formula (I) according to the present invention are used as a colorant.

Useful hydrophobic materials include for example secondary cellulose acetate, cellulose triacetate, polyamides and, in particular, high molecular weight polyesters. Materials of high molecular weight polyester are in particular those based on polyethylene glycol terephthalates.

The hydrophobic synthetic materials can be present in the form of sheet- or threadlike constructions and can have been processed, for example, into yarns or into woven or knit textile materials. Preference is given to fibrous textile materials, which may also be present in the form of microfibers for example.

The dyeing in accordance with the use provided by the present invention can be carried out in a conventional manner, preferably from an aqueous dispersion, if appropriate in the presence of carriers, at between 80 to about 110° C. by the exhaust process or by the HT process in a dyeing autoclave at 110 to 140° C., and also by the so-called thermofix process, in which the fabric is padded with the dyeing liquor and subsequently fixed/set at about 180 to 230° C.

Printing of the materials mentioned can be carried out in a manner known per se by incorporating the dye or dye mixtures of formula (I) of the present invention in a print paste and treating the fabric printed therewith at temperatures between 180 to 230° C. with HT steam, high-pressure steam or dry heat, if appropriate in the presence of a carrier, to fix the dye.

The dyes and dye mixtures of formula (I) of the present invention shall be in a very fine state of subdivision when they are used in dyeing liquors, padding liquors or print pastes.

The dyes are converted into the fine state of subdivision in a conventional manner by slurrying the as-fabricated dye together with dispersants in a liquid medium, preferably in water, and subjecting the mixture to the action of shearing forces to mechanically comminute the original dye particles to such an extent that an optimal specific surface area is achieved and sedimentation of the dye is minimized. This is accomplished in suitable mills, such as ball or sand mills. The particle size of the dyes is generally between 0.5 and 5 μm and preferably equal to about 1 μm.

The dispersants used in the milling operation can be nonionic or anionic. Nonionic dispersants include for example reaction products of alkylene oxides, for example ethylene oxide or propylene oxide, with alkylatable compounds, for example fatty alcohols, fatty amines, fatty acids, phenols, alkylphenols and carboxamides. Anionic dispersants are for example lignosulfonates, alkyl- or alkylarylsulfonates or alkylaryl polyglycol ether sulfates.

The dye preparations thus obtained should be pourable for most applications. Accordingly, the dye and dispersant content is limited in these cases. In general, the dispersions are adjusted to a dye content up to 50 percent by weight and a dispersant content up to about 25 percent by weight. For economic reasons, dye contents are in most cases not allowed to be below 15 percent by weight.

The dispersions may also contain still further auxiliaries, for example those which act as an oxidizing agent, for example sodium m-nitrobenzenesulfonate, or fungicidal agents, for example sodium o-phenylphenoxide and sodium pentachlorophenoxide, and particularly so-called “acid donors”, examples being butyrolactone, monochloroacetamide, sodium chloroacetate, sodium dichloroacetate, the sodium salt of 3-chloropropionic acid, monosulfate esters such as lauryl sulfate for example, and also sulfuric esters of ethoxylated and propoxylated alcohols, for example butylglycol sulfate.

The dye dispersions thus obtained are very advantageous for making up dyeing liquors and print pastes.

There are certain fields of use where powder formulations are preferred. These powders comprise the dye or dye mixture, dispersants and other auxiliaries, for example wetting, oxidizing, preserving and dustproofing agents and the abovementioned “acid donors”.

A preferred method of making pulverulent preparations of dye consists in stripping the above-described liquid dye dispersions of their liquid, for example by vacuum drying, freeze drying, by drying on drum dryers, but preferably by spray drying.

The dyeing liquors are made by diluting the requisite amounts of the above-described dye formulations with the dyeing medium, preferably water, such that a liquor ratio of 5:1 to 50:1 is obtained for dyeing. In addition, it is generally customary to include further dyeing auxiliaries, such as dispersing, wetting and fixing auxiliaries, in the liquors. Organic and inorganic acids such as acetic acid, succinic acid, boric acid or phosphoric acid are included to set a pH in the range from 4 to 5, preferably 4.5. It is advantageous to buffer the pH setting and to add a sufficient amount of a buffering system. The acetic acid/sodium acetate system is an example of an advantageous buffering system.

To use the dye or dye mixture in textile printing, the requisite amounts of the abovementioned dye formulations are kneaded in a conventional manner together with thickeners, for example alkali metal alginates or the like, and if appropriate further additives, for example fixation accelerants, wetting agents and oxidizing agents, to give print pastes.

The present invention also provides inks for digital textile printing by the ink jet process, comprising a present invention dye of the general formula (I).

The inks of the present invention are preferably aqueous and comprise one or more of the present invention's dyes of the general formula (I), for example in amounts of 0.1% to 50% by weight, preferably in amounts of 1% to 30% by weight and more preferably in amounts of 1% to 15% by weight based on the total weight of the ink. They further comprise in particular from 0.1% to 20% by weight of a dispersant. Suitable dispersants are known to one skilled in the art, are commercially available and include for example sulfonated or sulfomethylated lignins, condensation products of aromatic sulfonic acids and formaldehyde, condensation products of substituted or unsubstituted phenol and formaldehyde, polyacrylates and corresponding copolymers, modified polyurethanes and reaction products of alkylene oxides with alkylatable compounds, for example fatty alcohols, fatty amines, fatty acids, carboxamides and substituted or unsubstituted phenols.

The inks of the present invention may further comprise customary additives, for example viscosity moderators to set viscosities in the range from 1.5 to 40.0 mPas in the temperature range of 20 to 50° C. Preferred inks have a viscosity in the range from 1.5 to 20 mPas and particularly preferred inks have a viscosity in the range from 1.5 to 15 mPas.

Useful viscosity moderators include rheological additives, for example polyvinyl-caprolactam, polyvinylpyrrolidone and also their copolymers, polyetherpolyol, associative thickeners, polyureas, sodium alginates, modified galactomannans, polyetherurea, polyurethane and nonionic cellulose ethers.

By way of further additives, the inks of the present invention may include surface-active substances to set surface tensions in the range from 20 to 65 mN/m, which are if appropriate adapted depending on the process used (thermal or piezo technology). Useful surface-active substances include for example surfactants of any kind, preferably nonionic surfactants, butyldiglycol and 1,2 hexanediol.

The inks may further include customary additives, for example chemical species to inhibit fungal and bacterial growth in amounts from 0.01% to 1% by weight based on the total weight of the ink.

The inks of the present invention can be prepared in conventional manner by mixing the components in water.

### EXAMPLE 1

a) 8.0 g of the compound of formula (IIIa)

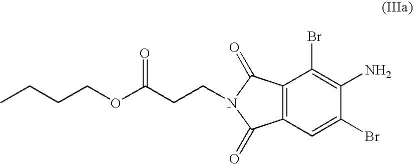

are introduced into a mixture of 84 ml of acetic acid and 28 ml of propionic acid at room temperature. After five minutes of stirring at 0-5° C., 5 ml of 40% nitrosylsulfuric acid are added dropwise and the mixture is subsequently stirred at that temperature for two hours. The reacted mixture is gradually added at 0-5° C. to a solution of 4.5 g of N,N-diethyl-m-toluidine in 39 ml of acetic acid and 13 ml of propionic acid before stirring for two hours. After the pH has been raised to 4.0 with sodium acetate, 314 ml of water are added and the mixture is subsequently stirred for five hours. The resulting suspension is filtered off with suction, washed with water and dried to leave 10.9 g of the compound of the formula (IIa)

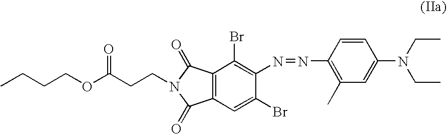

b) 7.0 g of the compound of formula (IIa) are suspended in 70 ml of NMP in a round-bottom flask. Addition of 0.5 g of imidazole, 0.7 g of copper(i) cyanide, 1.1 g of zinc cyanide and 1.3 g of sodium iodide is followed by stirring at 70° C. for 1.5 h. After cooling down, a solution of 2.9 g of iron(III) chloride in 150 ml of water is added dropwise before stirring for five hours. The suspension is filtered off with suction, washed with dilute hydrochloric acid and water and dried to leave 6.2 g of the present invention's dye of the formula (Ic)

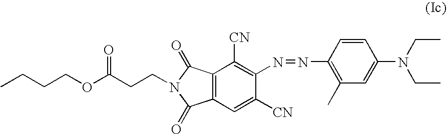

which dyes polyester in a slightly reddish blue shade.

Further inventive dyes obtainable by the above process are reported in table 1.

TABLE 1

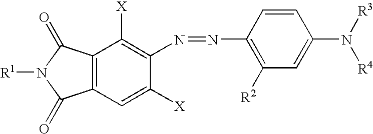

| | | | | | | | ₘₐₓ/ |
|---|---|---|---|---|---|---|---|
| Example | X | R¹ | R² | R³ | R⁴ | Hue | DMF |
| 2 | CN | C₂H₄COMe | Me | Et | Et | reddish | 594 |
| | | | | | | blue | |
| 3 | CN | C₂H₄COOEt | NHAc | Et | Et | blue | 607 |
| 4 | H | C₂H₄COOBu | H | EtCN | EtCN | orange | 443 |
| 5 | H | Et | H | EtCN | Et | yellowish | 466 |
| | | | | | | orange | |
| 6 | H | Et | H | EtCN | EtCN | reddish | 444 |
| | | | | | | yellow | |
| 7 | CN | C₃H₆COOEt | Me | Et | Et | reddish | 588 |
| | | | | | | blue | |
| 8 | CN | C₂H₄COOEt | Me | Et | Et | reddish | 590 |
| | | | | | | blue | |
| 9 | CN | C₃H₆COOEt | NHAc | Et | Et | blue | 604 |
| 10 | CN | C₃H₆COOEt | Me | Et | Et | reddish | 588 |
| | | | | | | blue | |
| 11 | CN | C₂H₄COOEt | Me | Et | Et | reddish | 590 |
| | | | | | | blue | |
| 12 | CN | C₂H₄COOEt | Me | Bu | EtOAc | reddish | 576 |
| | | | | | | blue | |
| 13 | CN | C₂H₄COOEt | Me | Bu | Prop | reddish | 584 |
| | | | | | | blue | |
| 14 | CN | CH₂COOMe | Me | Et | Et | reddish | 594 |
| | | | | | | blue | |
| 15 | CN | pentyl | Me | Et | Et | reddish | 588 |
| | | | | | | blue | |
| 16 | CN | (CH₂)₅COOEt | Me | Et | Et | reddish | |
| | | | | | | blue | |
| 17 | H | (CH₂)₅COOEt | H | EtCN | EtOAc | reddish | 466 |
| | | | | | | orange | |
| 18 | H | (CH₂)₅COOEt | Me | EtOAc | EtOAc | reddish | 474 |
| | | | | | | orange | |
| 19 | CN | C₂H₄COOBu | NHAc | Et | Et | blue | 601 |
| 20 | CN | (CH₂)₅COOEt | NHAc | Et | Et | blue | 603 |
| 21 | CN | CH₂COOEt | Me | Et | Et | reddish | 595 |
| | | | | | | blue | |
| 22 | CN | (CH₂)₂COOEt | NHAc | EtOMe | EtOMe | blue | 602 |
| 23 | H | n-butyl | H | EtOAc | EtOAc | yellowish | 465 |
| | | | | | | orange | |
| 24 | H | n-butyl | H | Et | EtCN | yellowish | 467 |
| | | | | | | orange | |
| 25 | CN | pentyl | NHSO₂Me | Et | Et | reddish | 592 |
| | | | | | | blue | |
| 26 | CN | tert-butyl | Me | Et | Et | reddish | 584 |
| | | | | | | blue | |
| 27 | CN | sec-butyl | Me | Et | Et | reddish | 590 |
| | | | | | | blue | |
| 28 | CN | isobutyl | Me | Et | Et | reddish | 590 |
| | | | | | | blue | |
| 29 | CN | isopropyl | Me | Et | Et | reddish | 588 |
| | | | | | | blue | |

### EXAMPLE 30

One part by weight of the dye of formula (Ic) is bead milled with 17 parts of water and two parts of a commercially available dispersant and subsequently converted into a 3% dispersion.

This dispersion is used to produce a 1% dyeing on woven polyester fabric by the high temperature exhaust process at 130° C., and the dyeing is reduction cleared with sodium dithionite. The dyeing thus obtained has very high washfastness.

### EXAMPLE 31

A textile fabric consisting of polyester is padded with a liquor consisting of 50 g/l of 8% sodium alginate solution, 100 g/l of 8-12% carob flour ether solution and 5 g/l of monosodium phosphate in water and then dried. The wet pickup is 70%. The textile thus pretreated is then printed with an aqueous ink prepared in accordance with the procedure described above and containing

3.5% of the dye of the formula (Ia),
2.5% of Disperbyk 190 dispersant,
30% of 1,5-pentanediol,
5% of diethylene glycol monomethyl ether,
0.01% of Mergal K9N biocide, and
58.99% of water
using a drop-on-demand (piezo) inkjet print head. The print is fully dried. Fixing is effected by means of superheated steam at 175° C. for 7 minutes. The print is subsequently subjected to an alkaline reduction clear, rinsed warm and then dried.

1-9. (canceled)

10. A dye of the formula (I) 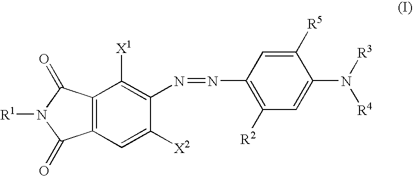
where
X¹ and X² are both hydrogen or both cyano;
R¹ is ethyl, straight-chain or branched (C₃-C₁₀)-alkyl or —(CH₂)ₙCOOR⁶;
R² is hydrogen, methyl, cyanomethyl, halomethyl, ethyl, cyanoethyl, haloethyl, halogen, —NH—CO—R⁷ or —NH—SO₂—R⁷;
R³ is (C₁-C₈)-alkyl or hydroxyl-, (C₁-C₄)-alkoxy-, cyano-, halogen-, R⁷OCO—, R⁷OOC—, vinyl- or phenyl-substituted (C₁-C₈)-alkyl;
R⁴ is hydrogen, (C₁-C₈)-alkyl or hydroxyl-, (C₁-C₄)-alkoxy-, cyano-, halogen-, R⁷OCO—, R⁷OOC—, vinyl or phenyl-substituted (C₁-C₈)-alkyl;
R⁵ is hydrogen, halogen, (C₁-C₄)-alkyl, (C₁-C₈)-alkoxy or halogen-, cyano- or phenyl-substituted (C₁-C₈)-alkoxy;
R⁶ is (C₁-C₄)-alkyl;
R⁷ is (C₁-C₈)-alkyl or halogen- or cyano-substituted (C₁-C₈)-alkyl; and
n is 1, 2, 3, 4 or 5;
except that
compounds in which R¹ is ethyl or n-butyl X¹ and X² are both cyano and R² is —NH—CO—R⁷, where R⁷═C₁-alkyl;
compounds in which R¹ is ethyl or n-butyl, X¹ and X² are both hydrogen and R² is —NH—CO—R⁷ or —NH—SO₂—R⁷;
the compound in which R¹ is —(CH₂)ₙCOOR⁶ where n 2 and R⁶═C₁-alkyl, X¹ and X² are both hydrogen, R² is —NH—CO—R⁷ where R⁷═C₂-alkyl, one of R³ and R⁴ is C₂-alkyl and the other is R⁷OCO-substituted C₂-alkyl where R⁷═C₁-alkyl and R⁵ is hydrogen;
compounds in which R¹ is branched C₃-alkyl, X¹ and X² are both hydrogen, 12 is —NH—CO—R⁷ where R⁷═C₃-alkyl, R³ and R⁴ are both C₂-alkyl and R⁵ is hydrogen; and
compounds in which R¹ is isobutyl, X¹ and X² are both hydrogen, R² is —NH—CO—R⁷ where R⁷═C₆-alkyl or is —NH—SO₂—R⁷ where R⁷═C₁-alkyl, 13 and R⁴ are both C₂-alkyl and R⁵ is hydrogen;
shall be excluded.

11. The dye as claimed in claim 10, wherein R⁵ is hydrogen.

12. The dye as claimed in claim 10, conforming to the formula (Ia) 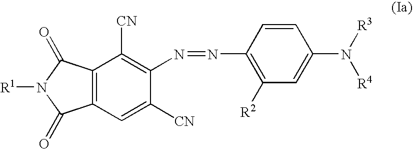
where
R¹ is n-pentyl or —(CH₂)ₙCOOR⁶;
R² is methyl, —NH—CO-methyl or —NH—SO₂-methyl;
R³ and R⁴ are independently ethyl, —(CH₂)₂CN, —(CH₂)₂OMe, —(CH₂)₂OAc, or n-butyl;
R⁶ is methyl, ethyl or butyl; and
n is 1, 2 or 3.

13. The dye as claimed in claim 11, conforming to the formula (Ia) 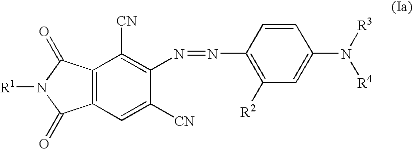
where
R¹ is n-pentyl or —(CH₂)ₙCOOR⁶;
R² is methyl, —NH—CO-methyl or —NH—SO₂-methyl;
R³ and R⁴ are independently ethyl, —(CH₂)₂CN, —(CH₂)₂OMe, —(CH₂)₂OAc, or n-butyl;
R⁶ is methyl, ethyl or butyl; and
n is 1, 2 or 3.

14. The dye as claimed in claim 10, conforming to the formula (Ib) 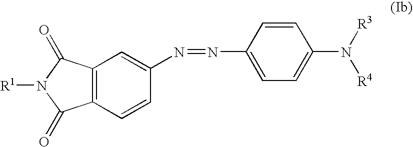
where
R¹ is ethyl or —(CH₂)ₙCOOR⁶;
R³ and R⁴ are independently ethyl, —(CH₂)₂CN, —(CH₂)₂OMe, —(CH₂)₂OAc, or n-butyl;
R⁶ is methyl, ethyl or butyl; and
n is 1, 2, 3 or 5.

15. The dye as claimed in claim 11, conforming to the formula (Ib) 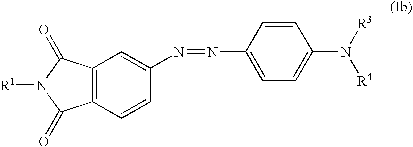
where
R¹ is ethyl or —(CH₂)ₙCOOR⁶;
R³ and R⁴ are independently ethyl, —(CH₂)₂CN, —(CH₂)₂OMe, —(CH₂)₂OAc, or n-butyl;
R⁶ is methyl, ethyl or butyl; and
n is 1, 2, 3 or 5.

16. The dye as claimed in claim 10, conforming to the formula (Ic) 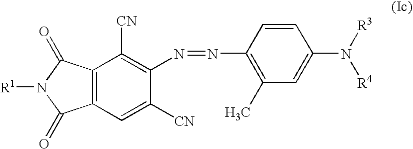
where
R¹ is isopropyl, isobutyl, sec-butyl or tert-butyl; and
R³ and R⁴ are independently ethyl, —(CH₂)₂CN, —(CH₂)₂OMe, —(CH₂)₂OAc, or n-butyl.

17. The dye as claimed in claim 11, conforming to the formula (Ic) 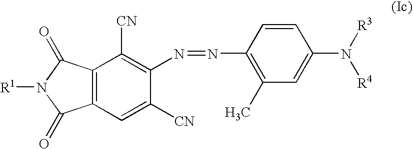
where
R¹ is isopropyl, isobutyl, sec-butyl or tert-butyl; and
R³ and R⁴ are independently ethyl, —(CH₂)₂CN, —(CH₂)₂OMe, —(CH₂)₂OAc, or n-butyl.

18. A process for preparing the dye as claimed in claim 10, wherein X¹ and X² are
both cyano which comprises cyanating a compound of the formula (II) 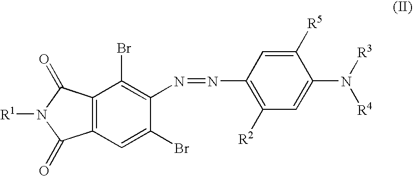
where R¹ to R⁵ are each as defined in claim 10.

19. A process for preparing the dye as claimed in claim 10, wherein X¹ and X² are both hydrogen which comprises diazotizing a compound of the formula (VII) 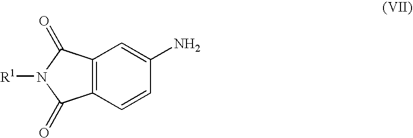
where R¹ is as defined in claim 10, and coupling onto a compound of the formula (IV) 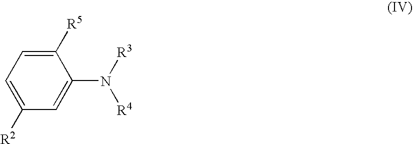
where R² to R⁵ are each as defined in claim 10.

20. A method for dyeing a hydrophobic material which comprises contacting the dye as claimed in claim 10 with the material.

21. A method for printing a hydrophobic material which comprises contacting the dye as claimed in claim 10 with the material.

22. An ink for digital textile printing by the ink jet process comprising the dye as claimed in claim 10.
